(19) United States
(12) Patent Application Publication
(10) Pub. No.: US 2021/0030618 A1
(43) Pub. Date: Feb. 4, 2021

(54) CALF MASSAGE MODULE AND LEG MASSAGE DEVICE INCLUDING SAME

(71) Applicant: BODYFRIEND CO., LTD., Seoul (KR)

(72) Inventors: Ju Song HUR, Incheon (KR); Young Soo PARK, Seoul (KR)

(21) Appl. No.: 16/964,880

(22) PCT Filed: Jul. 12, 2018
(86) PCT No.: PCT/KR2018/007899

§ 371 Date: Jul. 24, 2020

(30) Foreign Application Priority Data
Jan. 25, 2018 (KR) 10-2018-0009135

(51) Int. Cl. A61H 15/00

(52) U.S. Cl. CPC A61H 15/0078; A61H 2015/0014; A61H 2205/106; A61H 2201/1695; A61H 2201/1207

(57) ABSTRACT

A calf massage module includes: at least one movable shaft inserted into a spring so as to move forward or rearward by the compression and expansion of the spring; a massage module housing having a movable shaft guide part for guiding the movement of the movable shaft; and a moving housing inserted into the massage module housing according to the movement of the movable shaft.

### TECHNICAL FIELD

The present invention relates to a calf massage module and a leg massage device including the same, and more specifically, to a calf massage module which provides a massage to a calf muscle of a user and a leg massage device including the same.

### BACKGROUND ART

Generally, leg massage devices massage lateral sides of calves of a user or additionally massage soles of the user.

To this end, the leg massage device includes an air cell having an airbag on a lateral side of a calf to provide air pressure to the lateral side of the calf for massage and a sole massage roller formed on a lower portion of the leg massage device for massage of a sole.

In this regard, the conventional leg massage device (refer to Utility Model Registration No. 20-0407310) has a massage function for a lateral side of a calf and a sole as described above. However, the leg massage device does not have a massage function for a rear side of a calf. Further, development of a leg massage device that provides a massage along a shape and curve of a calf beyond limitations of static massage provided using airbags is required.

### DISCLOSURE

### Technical Problem

The present invention is directed to providing a calf massage module which provides a massage to a calf muscle along a shape and curve of a rear side of the calf based on an elastic force.

The present invention is directed to providing a leg massage device which includes a calf massage module, which applies pressure to a rear side of a calf, and a vertical movement module, which moves the calf massage module upward or downward, so as to provide a massage to the rear side of the calf.

The problems to be solved by the present invention are not limited to the above-mentioned problems, and other problems that are not mentioned will be clearly understood by those skilled in the art from the following descriptions.

### Technical Solution

One aspect of the present invention provides a calf massage module which includes at least one movable shaft which is inserted into a spring and moves forward or rearward by compression and expansion of the spring, a massage module housing including a movable shaft guide part that guides movement of the movable shaft, and a moving housing inserted into the massage module housing according to the movement of the movable shaft.

The calf massage module may further include a roller fixing bracket which supports a shaft of a roller that massages a calf of a user, wherein the roller fixing bracket may be mounted in the moving housing, and the movable shaft may be connected with the roller fixing bracket.

The calf massage module may further include a supporting shaft connected to the roller fixing bracket and moving forward or rearward along a supporting shaft guide part formed in the massage module housing.

Movement of the supporting shaft may be limited by a hook protrusion formed on the supporting shaft guide part to prevent the moving housing from separating therefrom in a forward direction.

The supporting shaft may have a stepped shape corresponding to a hook protrusion formed on the supporting shaft guide part. A rear end portion of the supporting shaft may protrude outward from the massage module housing when moving rearward along the supporting shaft guide part.

One end of the spring may be in contact with a lower surface of the roller fixing bracket, and the other end may be in contact with a seating position formed in an inlet of the movable shaft guide part.

The calf massage module may further include at least one roller that massages a calf of a user and be mounted in the moving housing.

When an external force is applied to the roller, a degree of pressure to the moving housing may be changed according to a shape of the calf of the user, the spring may expand or be compressed, and the moving housing may move forward or rearward according to the compression or expansion of the spring.

The roller may have a shape that has a diameter that increases in directions from a central portion to both ends.

The roller may have a plurality of protrusions formed on a surface thereof in a longitudinal direction. The roller may have a plurality of protrusions formed on a surface thereof in different sizes in a longitudinal direction.

In the roller, the plurality of protrusions may be formed so that central points thereof are collinear in a longitudinal direction, and the largest protrusion of the plurality of protrusions is disposed in the middle thereof, and the other protrusions are symmetrically disposed in both directions in order of size so that the plurality of protrusions may be formed in the form of curved line in the longitudinal direction.

The massage module housing may be connected with a vertical movement module that is a driving power source that moves the calf massage module upward or downward.

Another aspect of the present invention provides a leg massage device which includes a calf massage module which includes a massage module housing, at least one movable shaft which is inserted into a spring and moves forward or rearward along a movable shaft guide part formed in the massage module housing according to compression and expansion of the spring, and a moving housing inserted into the massage module housing according to movement of the movable shaft and a vertical movement module connected with the massage module housing and pulling the calf massage module upward or downward.

The calf massage module may further include a roller fixing bracket that supports a shaft of the roller that massages a calf of a user, wherein the roller fixing bracket may be mounted in the moving housing, and the movable shaft may be connected with the roller fixing bracket.

The vertical movement module may include a vertical movement frame connected to the massage module housing and including a magnet, a driving power source which provides driving force to the vertical movement frame, and a guide rail which guides vertical movement of the vertical movement frame.

The leg massage device may further include a housing unit including a front housing, a rear housing, and a lower housing and limit sensors which are mounted on an upper end portion and a lower end portion of the rear housing and detect a magnetic force of the magnet.

The driving power source may include a motor and a lead screw that receives a rotating force from the motor to rotate and is formed to serve as an axis of the vertical movement of the vertical movement frame.

The calf massage module may further include a supporting shaft that moves forward or rearward along the supporting shaft guide part formed in the massage module housing when the movable shaft is moved and prevents the moving housing from separating therefrom in a forward direction by limiting the movement of the moving housing forward due to a hook protrusion formed on the supporting shaft guide part.

When the calf massage module is moved upward by the vertical movement module, an external force may be applied by a shape of the calf, and a degree of pressure applied to the moving housing may be changed so that the spring expands or is compressed, and simultaneously, the movable shaft may move forward or rearward, and the moving housing may be inserted into the massage module housing.

### Advantageous Effects

According to one aspect of the present invention, provided is a calf massage module which includes a coupling structure of a movable shaft and a spring so as to provide a uniform massage along a shape and curve of a calf and which has a form that prevents the coupling structure from being exposed to the outside to facilitate stabilization when the massage is performed.

Further, according to another aspect of the present invention, provided is a leg massage device which includes a calf massage module, which provides a massage to a rear side of a calf, to provide a massage to a calf muscle by additionally massaging the rear side of the calf beyond limitations of static massage that is performed only on a lateral side of a calf through airbags using air pressure.

### DESCRIPTION OF DRAWINGS

Various aspects are described with reference to the drawings, and herein, like reference numerals are generally used to designate like elements. In the following exemplary embodiments, for the purpose of description, a plurality of specific details are suggested in order to provide general understanding of one or more aspects. However, it will be apparent that the aspect(s) may be carried out without the specific details. In other examples, well-known structures and devices are illustrated in the form of a block diagram for easy description of one or more aspects.

FIG. 1 is an exploded perspective view of a calf massage module according to one embodiment of the present invention.

FIG. 2 is a front view of the calf massage module according to one embodiment of the present invention.

FIG. 3 is a side view of the calf massage module according to one embodiment of the present invention.

FIG. 4 is a cross-sectional view taken along line A-A′ in FIG. 3.

FIG. 5 is an exploded perspective view of a vertical movement module installed in a leg massage device according to one embodiment of the present invention.

FIG. 6 is a view illustrating the calf massage module installed in the leg massage device according to one embodiment of the present invention.

FIG. 7 is a view illustrating an example in which the calf massage module according to one embodiment of the present invention is actually applied.

### BEST MODES OF THE INVENTION

A calf massage module includes at least one movable shaft which is inserted into a spring and moves forward or rearward by compression and expansion of the spring, a massage module housing which includes a movable shaft guide part that guides movement of the movable shaft, and a moving housing which is inserted into the massage module housing according to the movement of the movable shaft.

### MODES OF THE INVENTION

Purposes, features, and advantages of the present invention will be made clear from the following exemplary embodiments in connection with the accompanying drawings. The following specific structures or functional descriptions are illustrated for describing embodiments according to the concept of the present invention, and the embodiments according to the concept of the present invention may be implemented in various forms and should not be construed as being limited to the embodiments described in this specification or application.

While the embodiments according to the present invention are susceptible to various modifications and alternative forms, specific embodiments thereof will be shown by way of example in the drawings and described in detail in the specification or application. However, it should be understood that there is no intent to limit the embodiments according to the present invention to the particular forms disclosed, and the embodiments are to cover all modifications, equivalents, and alternatives falling within the spirit and scope of the invention.

Although the terms “first,” “second,” etc. may be used to describe various elements, these elements are not limited by the terms. The terms are only used to distinguish one element from another. For example, a first element may be termed a second element, and, similarly, a second element may be termed a first element without departing from the scope of the present invention.

When an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion, that is, expressions such as “between” and “immediately between” or “adjacent to” and “directly adjacent to” should be interpreted similarly.

The terms used in this specification are for the purpose of describing particular embodiments only and are not intended to limit the invention. Singular forms are intended to include plural forms as well, unless the context clearly indicates otherwise. In the specification, the terms “comprise,” “include,” and the like specify the presence of stated features, integers, steps, operations, elements, components, or combinations thereof but do not preclude the presence or addition of one or more other features, integers, steps, operations, elements, components, or combinations thereof.

Unless otherwise defined, all terms used herein, including technical or scientific terms, have the same meaning as commonly understood by a person skilled in the art to which the present invention pertains. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, embodiments of the present invention will be described in detail with reference to the accompanying drawings.

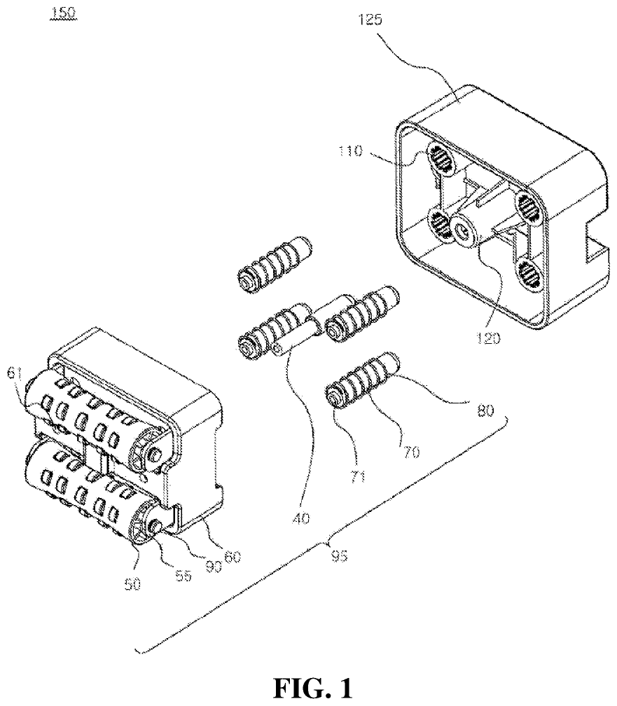

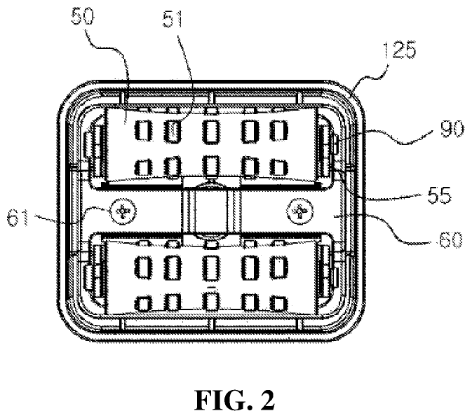

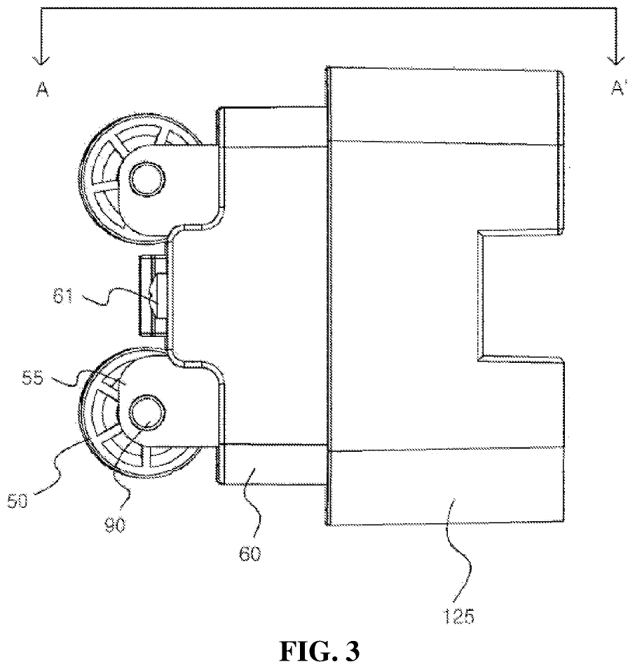

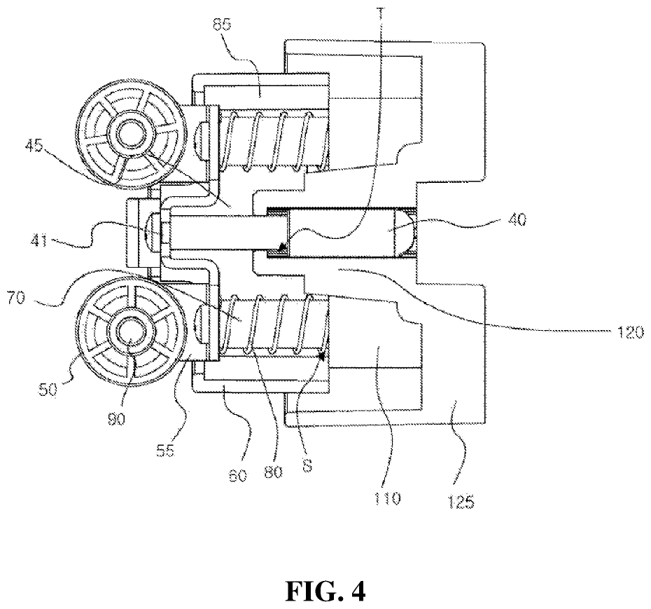

FIG. 1 is an exploded perspective view of a calf massage module according to the embodiment of the present invention, FIG. 2 is a front view of the calf massage module according to one embodiment of the present invention, FIG. 3 is a side view of the calf massage module according to the embodiment of the present invention, and FIG. 4 is a cross-sectional view taken along line A-A′ in FIG. 3.

A calf massage module 150 is a module that massages a rear side of a calf of a user and provides a massage to a calf muscle along a shape and curve of the calf. The calf massage module 150 may apply pressure to the rear side of the calf by moving on the rear side of the calf in an upward or downward direction. To this end, the calf massage module 150 may include a massage module housing 125 and a unit massage module 95. Further, the calf massage module 150 may be included as one component of a leg massage device described below.

The massage module housing 125 is formed as an entire frame of the calf massage module 150, and the unit massage module 95 may be installed in the calf massage module 150. The massage module housing 125 may be mounted on a driving power source that moves the calf massage module 150 upward or downward. Therefore, the calf massage module 150 may move upward or downward along the rear side of the calf.

The unit massage module 95, which is a module that directly massages a calf, includes a moving housing 60. The moving housing 60 includes a front end portion in which a roller fixing bracket 55 described below is installed, a lateral part which is bent from the front end portion, and a rear end portion which has a form corresponding to an outer circumferential surface of the lateral part. The moving housing 60 includes a space 85 formed by the lateral part, and the space 85 may be opened using the rear end portion.

The unit massage module 95 may include at least one roller 50 that massages a rear side of the calf of the user. The roller 50 may be installed in the moving housing 60 by the roller fixing bracket 55 that supports a shaft 90 of the roller 50. The roller 50 may be provided as the plurality of rollers or installed in the moving housing 60. For example, a pair of rollers 50 may be installed in a vertical direction of the moving housing 60 to provide a uniform massage to the rear side of the calf and reduce loads to the structure thereof, but the installation form or the number of the rollers are not limited.

The unit massage module 95 may include a movable shaft 70. The movable shaft 70 is inserted into the spring 80 and may be accommodated in the space 85 formed in the moving housing 60. Therefore, the unit massage module 95 is movable forward or rearward along the shape of the rear side of the calf to provide a massage to correspond to the shape of the calf.

The number of movable shafts 70 included in the unit massage module 95 may vary. For example, the unit massage module 95 may include one movable shaft 70 or include four movable shafts 70 each formed at edges of the space in the moving housing 60, but the number of movable shafts is not limited thereto.

Further, the unit massage module 95 may further include a supporting shaft 40 that complements a supporting force of the unit massage module 95 and prevents the unit massage module 95 from separating therefrom in a forward direction. In this case, the number of supporting shafts 40 and the installation form thereof may vary. For example, the movable shaft 70 provided as a pair of movable shafts may be installed in a longitudinal direction of the roller 50, and the supporting shaft 40 may be installed between the pair of movable shafts 70, but the number of the supporting shafts and the installation form thereof are not limited thereto.

More specifically, the massage module housing 125 may have an inner space into which the rear end portion and the lateral portion of the moving housing 60 is at least partially inserted, and at least one movable shaft guide part 110, which guides movement of the movable shaft 70, and at least one supporting shaft guide part 120, which guides movement of the supporting shaft 40, may be formed in the inner space.

The movable shaft guide part 110 and the supporting shaft guide part 120 may be formed to correspond to the number of movable shafts 70 and supporting shafts 40 and the installation form thereof. The movable shaft guide part 110 and the supporting shaft guide part 120 will be described below in detail. The massage module housing 125 may be mounted on a driving power source that moves the calf massage module 150 upward or downward. Therefore, the calf massage module 150 may move upward or downward along the rear side of the calf.

The unit massage module 95 may include the moving housing 60 that moves forward or rearward to be inserted into the massage module housing 125. The roller fixing bracket 55 that supports the shaft 90 of the roller 50 may be installed on the front end portion of the moving housing 60 by a fastening unit 61 (for example, a screw). That is, the roller 50 may be installed in the moving housing 60 using the roller fixing bracket 55. The roller 50 naturally rotates according to a vertical movement of the massage module housing 125 while in contact with the rear side of the calf of the user so as to provide a massage to the rear side of the calf.

Referring to FIG. 2, the roller 50 may include one or more protrusions 51 formed on a surface thereof so as to maximize an effect of massage. The one or more protrusions 51 may be formed in a longitudinal direction of the roller 50.

Further, the plurality of protrusions 51 may be formed to have different sizes. The plurality of protrusions 51 are formed in a longitudinal direction of the roller 50 but may be formed so that central points are collinear in the longitudinal direction. Further, the largest protrusion of the plurality of protrusions 51 may be positioned in the middle, and the other protrusions may be symmetrically arranged in both directions in order of size. In this case, the plurality of protrusions 51 may be arranged on a surface of the roller 50 in a longitudinal direction in the form of curved line. Further, the form of the roller 50 may be cylindrical, but the roller 50 may have a shape having a diameter that increases in directions from the middle to both ends, and thus the roller 50 comes into close contact with the rear side of the calf so that a massage is provided more effectively.

The unit massage module 95 may include the movable shaft 70 provided as one or more movable shafts. For example, the moving housing 60 may include the four movable shafts 70.

The movable shaft 70 may be connected to the moving housing 60. For example, the movable shaft 70 may be connected to the roller fixing bracket 55 mounted in the moving housing 60.

Referring to FIGS. 1 and 4, movable shaft protrusions 71 may be formed on a front end portion of the movable shaft 70, and the movable shaft 70 may be installed in the roller fixing bracket 55 in the space 85, which is formed in the moving housing 60, by the movable shaft protrusions 71. The rear end portion of the movable shaft 70 may be inserted into the movable shaft guide part 110.

Referring to FIGS. 1 and 4, a lower surface of the roller fixing bracket 55 is positioned in the space 85 formed in the moving housing 60 to face the massage module housing 125. The movable shaft 70 may be inserted into the spring 80, and the spring 80 may have one end portion positioned in contact with a lower surface of the roller fixing bracket 55 and the other end positioned in contact with a seating position S formed in an inlet of the movable shaft guide part 110. Therefore, the spring 80 may be blocked by the seating position S and the lower surface of the roller fixing bracket 55, and the spring 80 may be accommodated in the space 85 formed in the moving housing 60.

The spring 80 may expand or be compressed in the space 85, and thus the moving housing 60 moves forward or rearward along the shape of the rear side of the calf to perform a massage along the shape of the calf. That is, due to the shape of the rear side of the calf at any point, when an external force is not applied to the roller 50, the spring 80 is not compressed, and the moving housing 60 also does not move forward or rearward. However, when the massage module housing 125 moves upward and downward, the shape of the rear side of the calf that comes into contact with the roller 50 is changed so that an external force is applied to the roller 50, the spring 80 expands or is compressed, and the moving housing 60 may move forward or rearward. This will be described below in detail.

Meanwhile, the movable shaft guide part 110 may guide the front-rear movement of the movable shaft 70 according to compression and expansion of the spring 80. As described above, the movable shaft guide part 110 may be formed in the inner space of the massage module housing 125 and have the seating position S of the spring 80 and an inlet into which the lower portion of the movable shaft 70 is inserted, wherein the opposite side of the inlet may be blocked.

The unit massage module 95 is positioned in the moving housing 60 and may include the supporting shaft 40 that has a form that extends from the moving housing 60 to the massage module housing 125.

The supporting shaft 40 may be connected to the roller fixing bracket 55 mounted in the moving housing 60.

Referring to FIGS. 1 and 4, the supporting shaft 40 may be formed in a cylindrical form. Specifically, the supporting shaft 40 may include a first half part coupled to the roller fixing bracket 55 and extending from a front end portion, which forms an upper surface of a cylindrical form, in an axial direction and a second half part extending from the first half part to a rear end portion that forms a lower surface of the cylindrical form. In this case, a length of the first half part may vary. For example, the length of the first half part may be half of the entire length but is not limited thereto. Further, the form of the rear end portion of the supporting shaft 40 may vary. For example, the form of the rear end portion of the supporting shaft 40 may be semicircular but is not limited thereto.

The front end portion of the supporting shaft 40 may be installed on the roller fixing bracket 55 by a fastening unit 41 (for example, screw), and the rear end portion of the supporting shaft guide part 120 may be inserted into the supporting shaft guide part 120. The supporting shaft 40 may move along the supporting shaft guide part 120 when the movable shaft 70 moves according to compression and expansion of the spring 80.

Meanwhile, the supporting shaft guide part 120 may guide a front-rear movement of the supporting shaft 40 according to the compression and expansion of the spring 80. As described above, the supporting shaft guide part 120 may be formed in the inner space of the massage module housing 125.

Referring to FIG. 4, a hook protrusion T may be formed on an inlet of the supporting shaft guide part 120, and the side opposite to the inlet may be open outward from the massage module housing 125. Therefore, the front end portion of the supporting shaft 40 may be inserted into the supporting shaft guide part 120 from the outside of the massage module housing 125, may pass through the inlet, may come into contact with the lower surface of the roller fixing bracket 55 on a lower portion of the moving housing 60, and may be fixedly coupled to the roller fixing bracket 55 by the fastening unit 41 inserted from the front surface of the roller fixing bracket 55.

Further, the supporting shaft 40 may be formed in a stepped form to correspond to the hook protrusion T of the supporting shaft guide part 120. Specifically, an outer diameter of the first half part may be formed narrower than an outer diameter of a second half part. Therefore, a forward movement of the second half part of the supporting shaft 40 may be limited.

For example, when the spring 80 is compressed, the supporting shaft 40 may move rearward, the first half part of the supporting shaft 40 is moved rearward in the movement space 45, which is formed in the moving housing 60, by the rear surface of the roller fixing bracket 55 and the inlet of the supporting shaft guide part 120 so as to be inserted into the supporting shaft guide part 120. Further, the second half part of the supporting shaft 40 may move rearward along the supporting shaft guide part 120. In this case, the second half part of the supporting shaft 40 may protrude outward from the massage module housing 125.

Further, when the spring 80 expands, the supporting shaft 40 may move forward, and the first half part of the supporting shaft 40 may move forward in the movement space 45 formed in the moving housing 60. Further, the first half part of the supporting shaft 40 passes through the hook protrusion T and moves from the inside of the supporting shaft guide part 120 to the movement space 45.

The second half part of the supporting shaft 40 moves forward along the supporting shaft guide part 120 or moves from the outside of the massage module housing 125 to the supporting shaft guide part 120. However, since the second half part of the supporting shaft 40 is stopped by the hook protrusion T formed in the supporting shaft guide part 120, the second half part of the supporting shaft 40 cannot move from the supporting shaft guide part 120 to the movement space 45 formed in the moving housing 60. Like this, movement of the supporting shaft 40 is limited by a stepped part of the supporting shaft 40 and the hook protrusion T formed in the supporting shaft guide part 120, and thus the moving housing 60 is prevented from separating therefrom in a forward direction.

Hereinafter, to aid in the understanding of the operation of the invention, the leg massage device including the calf massage module 150 according to the embodiment of the present invention as one component will be described.

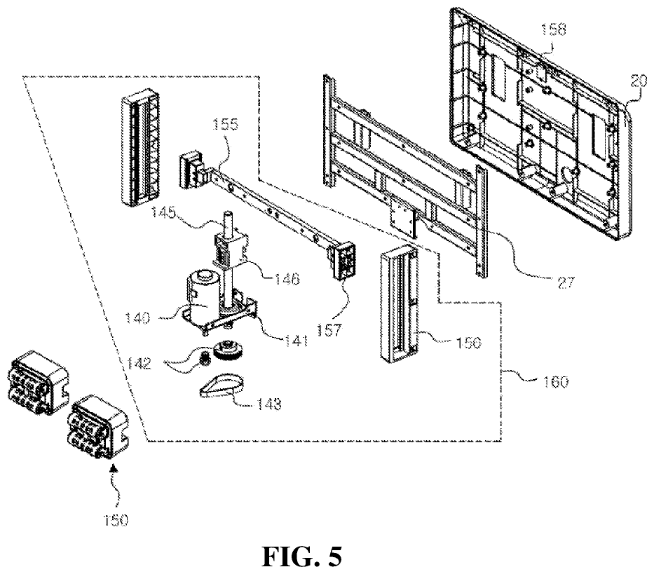

FIG. 5 is an exploded perspective view of a vertical movement module installed in the leg massage device according to an embodiment of the present invention.

A vertical movement module 160 may be installed in a rear housing 20 positioned on a rear surface of the leg massage device. A separate installation frame 27 is installed in an inner surface of the rear housing 20, and the vertical movement module 160 may be installed in the installation frame 27.

Meanwhile, the leg massage device may include, as a body that forms the entire appearance and accommodates various components formed therein, a housing unit including a front housing, a rear housing 20, and a lower housing.

The front housing is positioned on a front side of the leg massage device and may include a pair of accommodation spaces into which legs of a user are inserted. The user may get a massage after insertion of the legs into the accommodation spaces.

The vertical movement module 160 may be accommodated into a space formed by the front housing and the rear housing 20. However, the calf massage module 150 is installed in the vertical movement module 160 and massages calves of the user while facing the calves of the user in the accommodation spaces. The lower housing, which forms a lower portion of the leg massage device, may include wheels installed thereon in some cases.

The calf massage module 150 may massage the rear sides of the calves of the user by being moved vertically by the vertical movement module 160, and detailed descriptions thereof will be replaced with the above descriptions. A conventional leg massage device massages only a lateral side of a calf using air cells that provide air pressure for the lateral side of the calf, but the leg massage device according to the present invention may provide a uniform massage to the entire muscle of the calf along the shape of the calf by additionally massaging the rear side of the calf.

The leg massage device may further include a sole massage module besides the calf massage module 150. The sole massage module is a module that massages a sole and may be installed in the lower housing. The sole massage module includes a roller that receives driving force and rotates, and the roller may provide a sole massage.

Specifically, the vertical movement module 160, which is a module that vertically moves the calf massage module 150, is connected to the massage module housing 125 to move the massage module housing 125 upward or downward. To this end, the vertical movement module 160 includes a driving power source 140 and 145, a vertical movement frame 155 which is moved by the driving power source 140 and 145 and in which the calf massage module 150 is mounted, a guide rail 156 that guides a vertical movement of the vertical movement frame 155, and a limit sensor 158 that detects the vertical movement of the vertical movement frame 155.

The driving power source may include a motor 140, a lead screw 145, and a driving link 146. The motor 140 may be installed in the installation frame 27 by a motor bracket 141. A rotating force of the motor 140 may be transferred to the lead screw 145. The rotating force of the motor 140 may be transferred to the lead screw 145 by a timing belt 143 that fastens a pulley 142 mounted on the motor 140 and the lead screw 145, and thus the lead screw 145 may rotate. The lead screw 145 may be inserted into the driving link 146.

The driving link 146 may be a gear box of a box-shaped frame, in which various gears for transferring driving force are embedded, and may include, for example, a rotating gear engaged with the leas screw 145 to vertically move according to the rotation of the lead screw 145. Therefore, the driving link 146 may move in a vertical direction according to the rotation of the lead screw 145 while using the lead screw 145 as a shaft. The driving link 146 may be connected to the vertical movement frame 155. Therefore, when a rotating force of the motor 140 is transferred to the lead screw 145 so that the lead screw 145 rotates, the vertical movement frame 155 may vertically move in the same direction as the driving link 146 vertically moving according to the rotation of the lead screw 145.

As described above, the vertical movement frame 155 includes the driving link 146 to be vertically movable. Further, the pair of calf massage modules 150 are installed on both sides of the vertical movement frame 155 so as to be vertically moved by the driving link 146.

The guide rail 156, which is a member that is mounted in the installation frame 27 and guides a vertical movement of the vertical movement frame 155, may be formed in a vertical direction of the rear housing 20. The guide rail 156 may be provided as a pair, but the number of the guide rails 156 is not limited thereto. Meanwhile, sliders 157 may be formed on both end portions of the vertical movement frame 155. The sliders 157 may vertically move along the guide rail 156, and thus the vertical movement frame 155 may move vertically. That is, the vertical movement frame 155 does not move along the guide rail 156 while in direct contact with the guide rail 156 but may move the guide rail 156 using the sliders 157.

The limit sensor 158 may detect information on the vertical movement of the vertical movement frame 155 and may transfer the detected information to a control module (not shown).

The limit sensor 158 may be mounted on an inner surface of the rear housing 20. The limit sensor 158 may be mounted on each of an upper end portion and a lower end portion of the rear housing 20 so as to limit the vertical movement of the vertical movement frame 155. Further, the limit sensor 158 may be mounted on any one of the upper end portion and the lower end portion of the rear housing 20.

A magnet (not shown) may be mounted in the vertical movement frame 155, and when the vertical movement frame 155 moves upward or downward and approaches within a predetermined distance, the limit sensor 158 may detect a magnetic field generated from the magnet mounted in the vertical movement frame 155. When the limit sensor 158 detects the magnetic field, corresponding information may be transferred to the control module that controls an entire operation of the leg massage device.

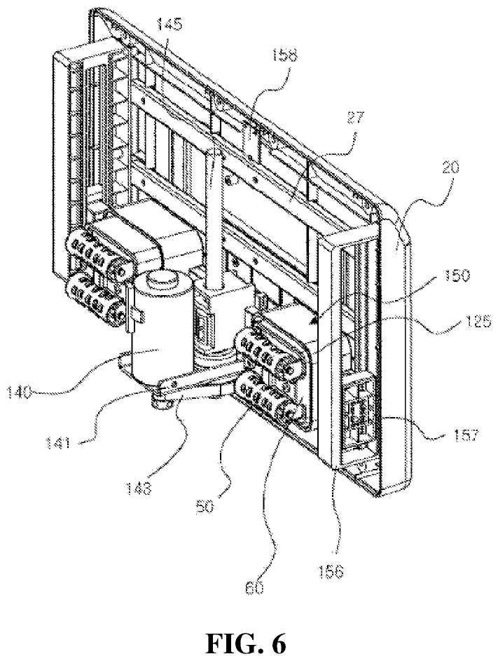

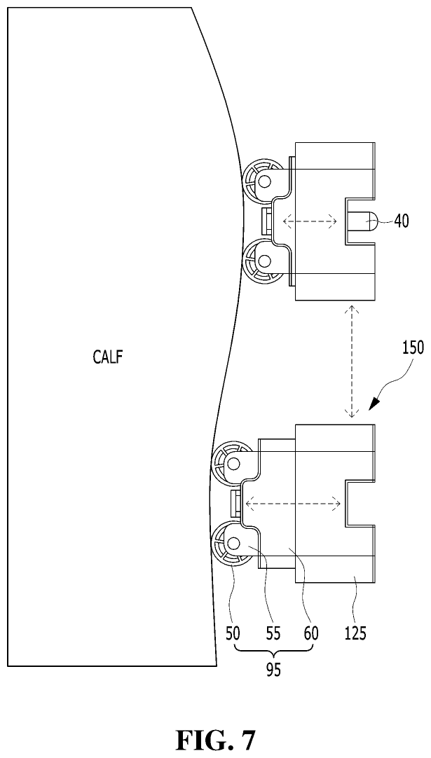

Hereinafter, referring to FIGS. 6 and 7, a process in which the calf massage module 150 included in the leg massage device according to the embodiment of the present invention massages the rear side of the calf by moving vertically will be described in more detail.

FIG. 6 is a view illustrating the calf massage module installed in the leg massage device according to the embodiment of the present invention, and FIG. 7 is a view illustrating an example in which the calf massage module according to the embodiment of the present invention is actually applied.

Referring to FIG. 6, the calf massage module 150 is positioned on a lowermost portion of the installation frame 27, and the driving motor 140 is not in operation. Further, the spring into which the movable shaft 70 that supports the roller 50 is inserted may be positioned in the space 85 formed in the moving housing 60 while not being compressed. Further, the roller 50 may be supported by the supporting shaft 40 besides the movable shaft 70, and the supporting shaft 40 can prevent the roller 50 and the moving housing from separating therefrom in a forward direction.

In the state in FIG. 6, when the driving motor 140 is operated, a rotating force is transferred to the driving link 146 by the lead screw 145, and the lead screw 145 receives the rotating force and pulls the driving link 146 upward while rotating.

Accordingly, the vertical movement frame 155 in which the driving link 146 is mounted may be movable upward along the guide rail 156, and the calf massage module 150 mounted in the vertical movement frame 155 is also movable upward. Meanwhile, since a thickness of the shape of calf is increased in an upward direction from an ankle portion, an external force is applied to the roller 50 that is in contact with a rear side of the calf.

As shown in FIG. 7, the moving housing 60 in which the roller 50 is mounted moves rearward so that a rear end portion of the moving housing 60 may be inserted into the massage module housing 125. Further, a rear end portion of the supporting shaft 40 may protrude outward from the massage module housing 125. Accordingly, since a degree of pressure to the spring 80 in the space 85 formed in the moving housing 60 is changed, the spring 80 expands or is compressed, and the moving housing 60 simultaneously moves forward or rearward to massage the rear side of the calf.

The above descriptions are only exemplary, and it should be understood by those skilled in the art that the invention may be performed in other specific forms without changing the technological scope and essential features. Therefore, it should be understood that the embodiments described above are illustrative in all respects and not restrictive. For example, each component described as a single type may be implemented in a distributed manner, and similarly, components described in a distributed manner may be implemented in a combined form.

The scope of the present invention is indicated by the following claims rather than the above detailed description, and it should be interpreted that all changes or modified forms derived from the meaning and scope of the claims and equivalent concepts thereof are included in the scope of the present invention.

1. A calf massage module comprising:
at least one movable shaft which is inserted into a spring and moves forward or rearward by compression and expansion of the spring;
a massage module housing including a movable shaft guide part that guides movement of the movable shaft; and
a moving housing which is inserted into the massage module housing according to the movement of the movable shaft.

2. The calf massage module of claim 1, wherein the calf massage module further includes a roller fixing bracket which supports a shaft of a roller that massages a calf of a user,
wherein the roller fixing bracket is mounted in the moving housing, and the movable shaft is connected with the roller fixing bracket.

3. The calf massage module of claim 2, wherein the calf massage module further includes a supporting shaft connected to the roller fixing bracket and moving forward or rearward along a supporting shaft guide part formed in the massage module housing.

4. The calf massage module of claim 3, wherein movement of the supporting shaft is limited by a hook protrusion formed on the supporting shaft guide part to prevent the moving housing from separating therefrom in a forward direction.

5. The calf massage module of claim 3, wherein the supporting shaft has a stepped shape corresponding to a hook protrusion formed on the supporting shaft guide part.

6. The calf massage module of claim 3, wherein a rear end portion of the supporting shaft protrudes outward from the massage module housing when moving rearward along the supporting shaft guide part.

7. The calf massage module of claim 2, wherein one end of the spring is in contact with a lower surface of the roller fixing bracket and the other end is in contact with a seating position formed in an inlet of the movable shaft guide part.

8. The calf massage module of claim 1, wherein the calf massage module further includes at least one roller that massages a calf of a user and is mounted in the moving housing.

9. The calf massage module of claim 8, wherein, when an external force is applied to the roller, a degree of pressure to the moving housing is changed according to a shape of the calf of the user, the spring expands or is compressed, and the moving housing moves forward or rearward according to the compression or expansion of the spring.

10. The calf massage module of claim 8, wherein the roller has a shape that has a diameter that increases in directions from a central portion to both ends.

11. The calf massage module of claim 8, wherein the roller has a plurality of protrusions formed on a surface thereof in different sizes in a longitudinal direction.

12. A leg massage device comprising:
a calf massage module which includes a massage module housing, at least one movable shaft which is inserted into a spring and moves forward or rearward along a movable shaft guide part formed in the massage module housing according to compression and expansion of the spring, and a moving housing which is inserted into the massage module housing according to movement of the movable shaft; and
a vertical movement module connected with the massage module housing and pushing or pulling the calf massage module upward or downward.

13. The leg massage device of claim 12, wherein the vertical movement module includes:
a vertical movement frame connected to the massage module housing and including a magnet mounted thereon;
a driving power source which provides driving force to the vertical movement frame; and
a guide rail which guides a vertical movement of the vertical movement frame.

14. The leg massage device of claim 13, wherein the leg massage device further includes a housing unit including a front housing, a rear housing, and a lower housing and limit sensors which are mounted on an upper end portion and a lower end portion of the rear housing and detect a magnetic force of the magnet.

15. The leg massage device of claim 13, wherein the driving power source includes:
a motor; and
a lead screw that receives a rotating force from the motor to rotate and is formed to serve as an axis of the vertical movement of the vertical movement frame.
